(19) United States
(12) Patent Application Publication
(10) Pub. No.: US 2009/0130334 A1
(43) Pub. Date: May 21, 2009

(54) Fabrication method and apparatus

(76) Inventor: Kwang-Leong Choy, Nottingham (GB)

Correspondence Address: DON W. BULSON;RENNER, OTTO, BOISSELLE & SKLAR, LLP, 1621 EUCLID AVENUE, 19TH FLOOR, CLEVELAND, OH, 44115, US

(21) Appl. No.: 10/545,288

(22) PCT Filed: Feb. 11, 2004
(86) PCT No.: PCT/GB2004/000553

§ 371 Date: Nov. 4, 2008

(30) Foreign Application Priority Data
Feb. 11, 2003 (GB) 0303070.7

(51) Int. Cl. B05D 3/06; C23C 18/14; B23K 26/08; C04B 41/45

(52) U.S. Cl. 427/553; 425/6; 264/10; 118/620; 264/401

(57) ABSTRACT

A fabrication method and apparatus, the method comprising the steps of: providing a liquid precursor over a surface of the substrate; and irradiating at least a region of the surface of the substrate with a light beam such as to fabricate a structure thereon from the liquid precursor.

The present invention relates to a method of and apparatus for fabricating three-dimensional objects, films and powders from a liquid precursor, in particular a solution.

The present invention finds particular application in relation to the fabrication of three-dimensional objects, in particular objects incorporating ceramic materials.

A stereolithographic technique, utilizing a ceramic suspension containing a ceramic powder and a monomer in an organic solvent, has been used to fabricate three-dimensional ceramic objects. This technique, whilst providing for the fabrication of three-dimensional objects, suffers from the particular disadvantages of requiring the use of a ceramic suspension, the fabrication of which is particularly time consuming in requiring ball milling for several hours, and only allowing for the fabrication of larger objects having a relatively-imprecise dimensional control and a relatively-coarse microstructure.

In relation to the fabrication of three-dimensional objects, the present invention, in fabricating objects from a liquid phase, provides a technique which enables the rapid fabrication of objects, in particular, but not exclusively, micro-objects, and provides for the fabrication of objects with precise dimensional control and a fine microstructure.

The present invention also provides an improved method and apparatus for fabricating films and powders, in particular films and powders incorporating ceramic materials.

In one aspect the present invention provides a fabrication method, comprising the steps of: providing a liquid precursor over a surface of the substrate; and irradiating at least a region of the surface of the substrate with a light beam such as to fabricate a structure thereon from the liquid precursor.

In another aspect the present invention provides a fabrication method for fabricating a three-dimensional structure, either as a three-dimensional object or as a three-dimensional coating on an object, of one a metal, ceramic, cermet material or an organic-inorganic hybrid material, the method comprising the steps of: providing a liquid precursor over a surface of the substrate; and irradiating at least a region of the surface of the substrate with a light beam such as to fabricate a three-dimensional structure thereon of one a metal, ceramic, cermet material or an organic-inorganic hybrid material from the liquid precursor.

In a further aspect the present invention provides a fabrication method, comprising the steps of: providing a reservoir of a liquid precursor; and irradiating the liquid precursor with a light beam such as to fabricate a powder from the liquid precursor.

In a yet further aspect the present invention provides a fabrication apparatus, comprising: a support unit for supporting a substrate; a liquid precursor provision unit for providing a liquid precursor over a surface of the substrate; and a lighting unit for irradiating at least a region over the surface of the substrate with a light beam to fabricate a structure thereon from the liquid precursor.

In yet another aspect the present invention provides a fabrication apparatus, comprising: a reservoir for containing a liquid precursor; and a lighting unit for irradiating liquid precursor in the reservoir to fabricate a powder from the liquid precursor.

Preferred embodiments of the present invention will now be described hereinbelow by way of example only with reference to the accompanying drawings, in which:

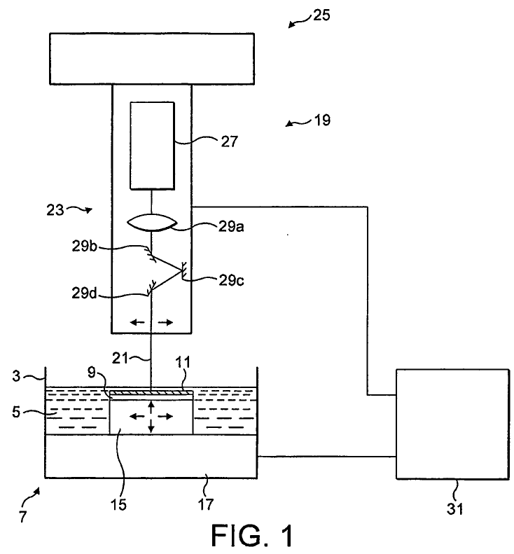

FIG. 1 schematically illustrates a fabrication apparatus in accordance with a first embodiment of the present invention;

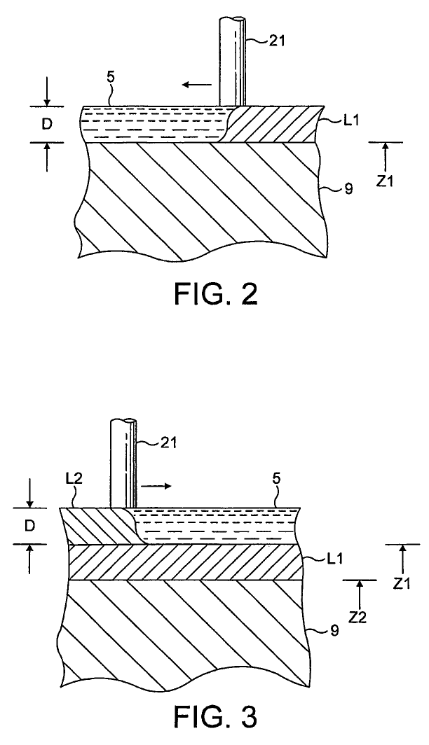

FIGS. 2 and 3 illustrate the operation of the lighting unit of the apparatus of FIG. 1 in the respective steps of fabricating first and second material layers of a three-dimensional object;

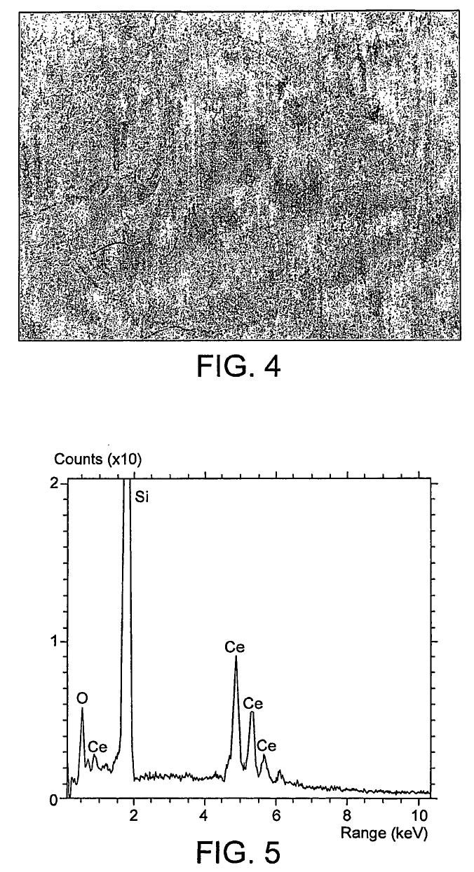

FIG. 4 illustrates a scanning electron micrograph (SEM) of a cerium oxide ring as fabricated using the apparatus of FIG. 1 in accordance with the described Example;

FIG. 5 is an energy-dispersive X-ray spectrum of the cerium oxide ring of FIG. 4;

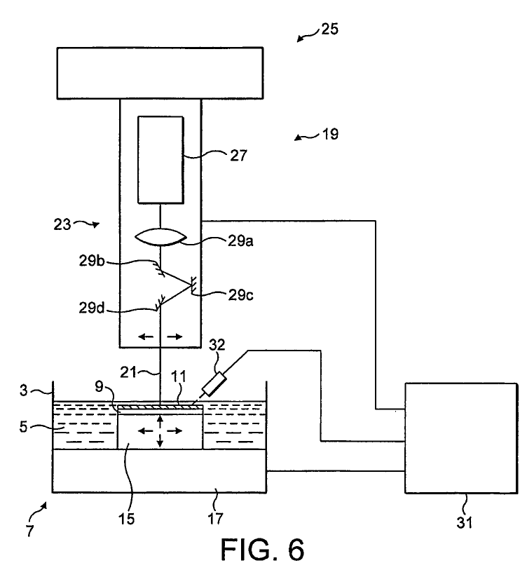

FIG. 6 schematically illustrates a fabrication apparatus in accordance with a second embodiment of the present invention;

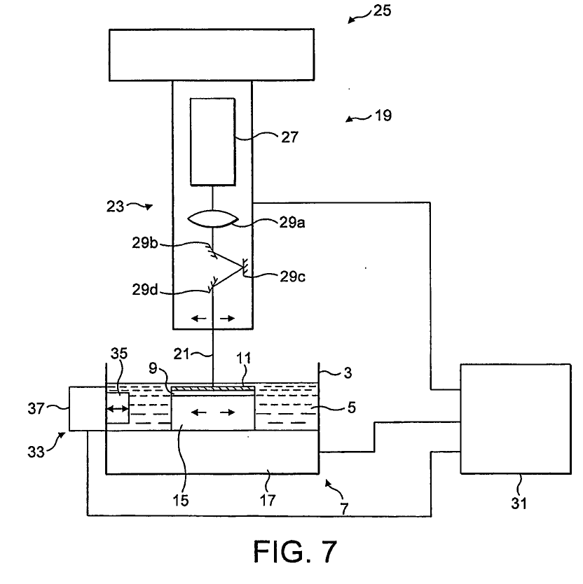

FIG. 7 schematically illustrates a fabrication apparatus in accordance with a third embodiment of the present invention;

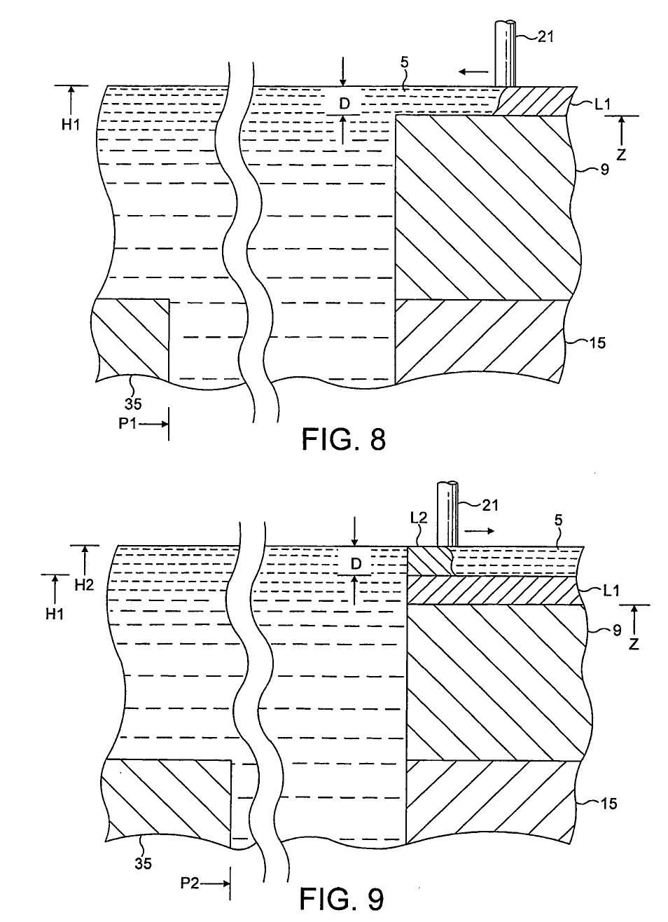

FIGS. 8 and 9 illustrate the operation of the lighting unit of the apparatus of FIG. 7 in the respective steps of fabricating first and second material layers of a three-dimensional object;

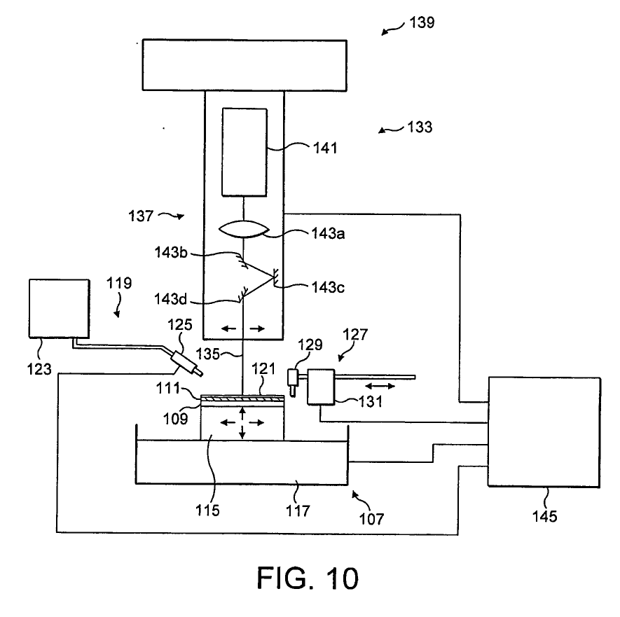

FIG. 10 schematically illustrates a fabrication apparatus in accordance with a fourth embodiment of the present invention;

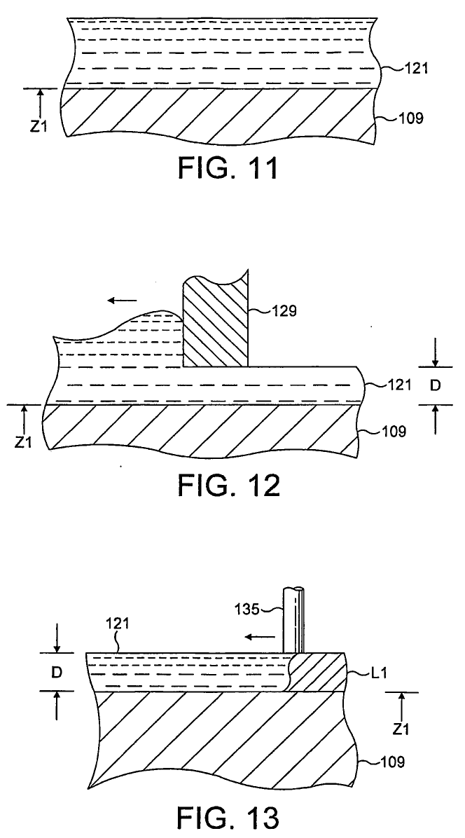

FIG. 11 illustrates the operation of the liquid precursor application unit of the apparatus of FIG. 10 in the application of a liquid precursor to a substrate in the step of fabricating a first material layer of a three-dimensional object;

FIG. 12 illustrates the operation of the film setting unit of the apparatus of FIG. 10 in providing a film of a predetermined depth over the substrate in the step of fabricating a first material layer of a three-dimensional object;

FIG. 13 illustrates the operation of the lighting unit of the apparatus of FIG. 10 in the step of fabricating a first material layer of a three-dimensional object;

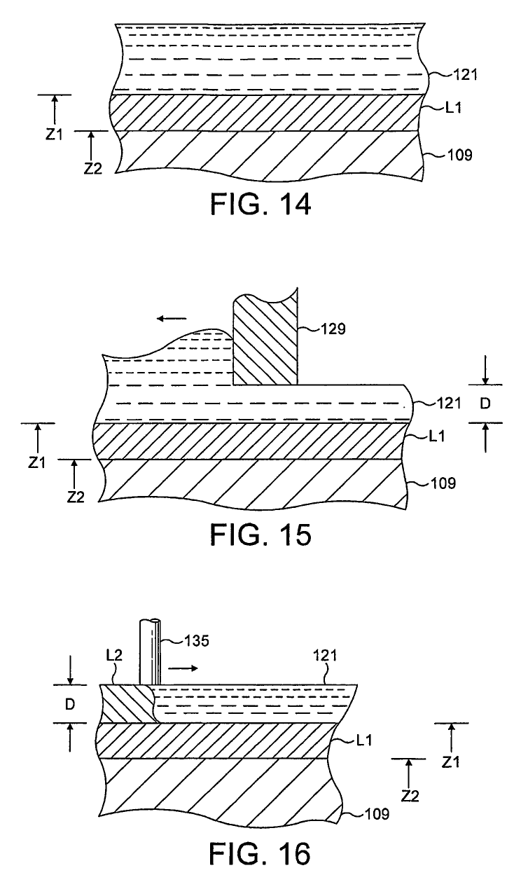

FIG. 14 illustrates the operation of the liquid precursor application unit of the apparatus of FIG. 10 in the application of a liquid precursor to a substrate in the step of fabricating a second material layer of a three-dimensional object;

FIG. 15 illustrates the operation of the film setting unit of FIG. 10 in providing a film of a predetermined depth over the substrate in the step of fabricating a second material layer of a three-dimensional object;

FIG. 16 illustrates the operation of the lighting unit of the apparatus of FIG. 10 in the step of fabricating a second material layer of a three-dimensional object; and

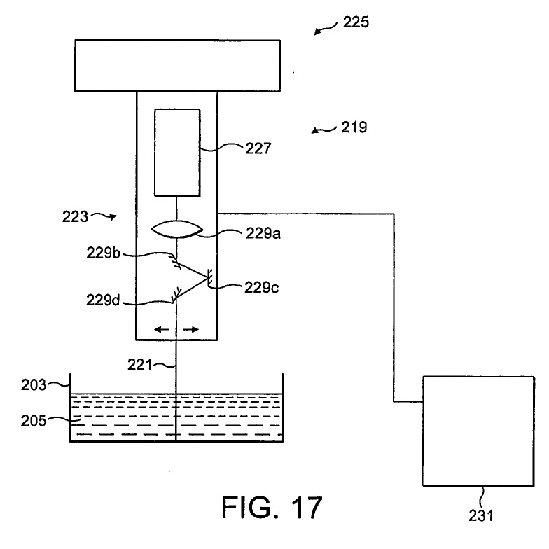

FIG. 17 schematically illustrates a fabrication apparatus in accordance with a fifth embodiment of the present invention.

FIG. 1 illustrates a fabrication apparatus in accordance with a first embodiment of the present invention.

The apparatus comprises a reservoir 3 for containing a liquid precursor 5, and a support unit 7 for supporting a substrate 9 in the reservoir 3 on which a three-dimensional object 11 is to be fabricated.

In this embodiment the liquid precursor 5 comprises a solution, in one embodiment a sol or colloidal solution. The liquid precursor 5 can be based on one or more of metal salts, including metal nitrates and metal sulphates, metal hydroxides, metal halides, metal hydrides, metal acetates, metalorganics, organometallics and alkoxides, where formulated with any of water and organic or inorganic solvents.

In one embodiment the liquid precursor 5 can include a photosensitizer which promotes the transfer of the photon energy to the chemical precursor.

In this embodiment the substrate 9 is formed of a ceramic material. In other embodiments the substrate 9 could be formed of metals, glasses or polymeric materials.

The support unit 7 comprises a movable platform 15 on which the substrate 9 is supported, and a platform positioner 17 which is operable to position the platform 15, and hence the supported substrate 9, in the reservoir 3.

In this embodiment the platform positioner 17 comprises a table, as a three-axis positioner, which is positionable in X, Y and Z axes.

In an alternative embodiment the platform positioner 17 could comprise a six-axis positioner which provides for both rotation and translation of the substrate 9.

As will be described in more detail hereinbelow, in this embodiment the platform positioner 17 provides for movement of the platform 15 in the Z axis in the fabrication of the three-dimensional object 11 such as to maintain a film of the liquid precursor 5 of a predetermined depth over the substrate 9.

The apparatus further comprises a lighting unit 19 for providing a light beam 21 to irradiate an upper surface of the substrate 9.

The lighting unit 19 comprises a light source 23 which generates the light beam 21 and a light beam positioner 25 which operates on the light source 23 such as position the light beam 21 selectively to irradiate regions over the substrate 9, in this embodiment by scanning the light beam 21 over the substrate 9.

In this embodiment the light source 23 comprises a light-emitting element 27, and optical elements 29 which are configurable by the light beam positioner 25 to provide for the selective positioning of the light beam 21.

In an alternative embodiment the light beam positioner 25 could be configured to move the entire light source 23.

In this embodiment the light-emitting element 27 comprises a laser, such as a CO₂ laser, a Nd-YAG laser and an excimer laser, which provides a focussed light beam. In one embodiment the laser could be a pulsed laser. In another embodiment could be a continuous laser.

The light beam 21 has an intensity which is such as induce one or both of the photothermal and/or photolytic reaction of the liquid precursor 5 at a surface on the substrate 9, which causes one or both of the dissociation and chemical reaction of the liquid precursor 5 at the surface on the substrate 9, and results in the deposition of a solid deposit. By selectively irradiating regions over the substrate 9, a three-dimensional object 11 can be fabricated in a layer-by-layer fashion, as will be described in more detail hereinbelow.

The apparatus further comprises a control unit 31 for controlling the support unit 7 and the lighting unit 19 in the fabrication of a three-dimensional object 11. In this embodiment the control unit 31 is a computer-controlled unit.

Operation of the apparatus will now be described hereinbelow with particular reference to FIGS. 2 and 3 of the accompanying drawings.

A substrate 9, on which a three-dimensional object 11 is to be fabricated, is first located on the platform 15 of the support unit 7.

As illustrated in FIG. 2, the substrate 9 is first positioned both in the X, Y plane and at a first height Z1 in the Z axis relative to the upper surface of the liquid precursor 5 such that a film of the liquid precursor 5 of a predetermined depth D is present over the substrate 9.

With the substrate 9 at the first height Z1, the lighting unit 19 is actuated such as to position the light beam 21 at selected regions over the substrate 9, in this embodiment by scanning the light beam 21, and thereby effects the deposition of material deposits over the substrate 9 in a first layer L1 having a pattern in accordance with the required three-dimensional object 11.

As illustrated in FIG. 3, following fabrication of the first layer L1, the substrate 9 is re-positioned at a second, lower height Z2 relative to the upper surface of the liquid precursor 5 such that a film of the liquid precursor 5 of the predetermined depth D is present over the substrate 9 as defined by the upper surface of the first layer L1 of deposited material.

With the substrate 9 at the second height Z2, the lighting unit 19 is actuated such as to position the light beam 21 at selected regions over the substrate 9, in this embodiment by scanning the light beam 21, and thereby effects the deposition of material deposits over the substrate 9 in a second layer L2 having a pattern in accordance with the required three-dimensional object 11.

This re-positioning of the height of the substrate 9 and the deposition of material layers is repeated until fabrication of the three-dimensional object 11 is complete.

The apparatus provides for the in situ fabrication of objects 11 of metals, including metal alloys, ceramics, cermet materials and organic-inorganic hybrid materials.

The apparatus also provides for the fabrication of composite materials, such as metal, ceramic and polymer matrix materials.

In one embodiment, where the liquid precursor 5 is a clear solution, both the matrix material and the reinforcement material can be formed in situ directly from the liquid precursor 5.

In another embodiment the liquid precursor 5 can comprise a solution containing a suspended reinforcement material, such as particles and fibres, with the matrix material being formed from the solution.

In a further embodiment a reinforcement material, such as particles and fibres, can be introduced into the liquid precursor 5 during conversion thereof into the matrix material.

In a yet further embodiment the re-inforcement can be provided by a skeletal pre-form which is penetrated by the liquid precursor 5. In one embodiment, in the fabrication of a three-dimensional object 11, a plurality of pre-forms can be successively stacked on one the other. In one embodiment the skeletal pre-form can be formed of a heat-conductive material such as to provide for transmission of the heat developed by the light beam 21 of the lighting unit 19.

The objects 11 can be formed as solid, dense parts or solid, porous parts, or comprise both solid and dense regions.

In one embodiment the liquid precursor 5 can be maintained at a predetermined temperature, whether heated or cooled relative to ambient, such as to provide for controlled material deposition, typically by regulating the temperature of the liquid precursor 5 or the platform 15 of the support unit 7 on which the substrate 9 is supported.

In another embodiment a temperature gradient can be maintained in the liquid precursor 5, decreasing in a direction from the surface of the substrate 9, such as to provide for dissociation and/or chemical reaction at the surface of the substrate 9.

In one embodiment the liquid precursor 5 can be heated to such a temperature that conversion of the liquid precursor 5 can be effected by a light beam 21 of relatively low energy.

In one embodiment the apparatus can be utilized in an open atmosphere.

In another embodiment the apparatus can be provided in a closed environment.

In one embodiment a gaseous reactant can be utilized in conjunction with the liquid precursor 5.

In one embodiment a gaseous reactant can be introduced into the liquid precursor 5, where either dissolved in or bubbled through the liquid precursor 5.

In another embodiment, where the apparatus is provided in a closed environment, the gaseous reactant can be introduced into the closed atmosphere.

In a further embodiment a vapor reactant can be utilized in conjunction with the liquid precursor 5.

In one embodiment, where the apparatus is provided in a closed environment, the vapor reactant can be introduced into the closed atmosphere.

In this embodiment the apparatus is utilized at atmospheric pressure.

In other embodiments the apparatus could be utilized at below or above atmospheric pressure.

### EXAMPLE

The present invention will now be described hereinbelow with reference to the following non-limiting Example.

A liquid precursor 5 comprising a solution of 0.1 M cerium nitrate in water was first prepared.

Using the fabrication apparatus of the above-described embodiment in an open atmosphere, where the light-emitting element 27 of the light source 23 comprises an argon ion laser at a wavelength of 514 nm and a laser power of 2.5 W and the light beam positioner 25 is configured to provide for the scanning of the light beam 21 at a speed of 50 μms⁻¹, a cerium oxide ring was deposited onto a silicon substrate.

FIG. 4 illustrates an SEM of the resulting cerium oxide ring (magnification ×55). FIG. 5 is an energy-dispersive X-ray spectrum of the resulting cerium oxide ring, which confirms that the deposited ring comprises only Ce and O, with no detectable impurities.

FIG. 6 illustrates a fabrication apparatus in accordance with a second embodiment of the present invention.

The fabrication apparatus of this embodiment is very similar to the fabrication apparatus of the above-described first embodiment, and thus, in order to avoid unnecessary duplication of description, only the differences will be described in detail with like parts being designated by like reference signs.

The fabrication apparatus of this embodiment differs from that of the above-described first embodiment in further comprising a film depth detector 32, in this embodiment an optical detector, for detecting the depth of the liquid precursor 5 over the surface of the substrate 9, and in that the control unit 31 is operative to control the support unit 7 to position the platform 15 thereof in accordance with the detected depth of the liquid precursor 5. With this configuration, the position of the platform 15 of the support unit 7 is not positioned to set, predetermined heights in accordance with a predetermined routine, but, rather through feedback from the film depth detector 32.

Operation of the apparatus of this embodiment is the same as for the apparatus of the above-described first embodiment, except that the height of the platform 15 of the support unit 7 is positioned through feedback from the film depth detector 32.

FIG. 7 illustrates a fabrication apparatus in accordance with a third embodiment of the present invention.

The fabrication apparatus of this embodiment is quite similar to the fabrication apparatus of the above-described first embodiment, and thus, in order to avoid unnecessary duplication of description, only the differences will be described in detail with like parts being designated by like reference signs.

The fabrication apparatus of this embodiment differs from that of the above-described first embodiment in that the platform 15 of the support unit 7 is of fixed height, in not being moved in the Z axis during operation, and in further comprising a liquid height setting unit 33 for setting the height of the liquid precursor 5 in the fabrication of a three-dimensional object 11 on the substrate 9.

The liquid height setting unit 33 comprises a displacement member 35 which is movable into the reservoir 3 such as to displace the contained liquid precursor 5 and thereby raise the level of the contained liquid precursor 5, and a drive 37 for moving the displacement member 35 to displace the liquid precursor 5.

In this embodiment, during the deposition of each layer of a three-dimensional object 11, the displacement member 35 is successively driven into the reservoir 3 by a predetermined amount such as to maintain the level of the liquid precursor 5 at a predetermined height above the upper surface on the substrate 9, and thereby maintain a film of the liquid precursor 5 of a predetermined depth over the substrate 9.

Operation of the apparatus of this embodiment is the same as for the apparatus of the above-described first embodiment, except that the platform 15 of the support unit 7 remains stationary during operation, and, following deposition of each layer of material on the substrate 9, the liquid height setting unit 33 is actuated to provide that the level of the liquid precursor 5 is at a predetermined height above the upper surface on the substrate 9, and thereby maintain a film of the liquid precursor 5 of a predetermined depth over the substrate 9.

As illustrated in FIG. 8, with the substrate 9 positioned at a fixed height Z and the displacement member 35 of the liquid height setting unit 33 in a first position P1, which is such as to set the level of the liquid precursor 5 at a first level H1 at which a film of the liquid precursor 5 of a predetermined depth D is maintained over the substrate 9, the lighting unit 19 is actuated such as to position the light beam 21 at selected regions over the substrate 9, in this embodiment by scanning the light beam 21, and thereby effects the deposition of material deposits over the substrate 9 in a first material layer L1 having a pattern in accordance with the required three-dimensional object 11.

As illustrated in FIG. 9, following fabrication of the first material layer L1 and with the substrate 9 at the fixed height Z, the displacement member 35 of the liquid height setting unit 33 is moved to a second position P2, which is such as to raise the level of the liquid precursor 5 to a second level H2 at which a film of the liquid precursor 5 of the predetermined depth D is maintained over the substrate 9 as defined by the upper surface of the first material layer L1.

With the level of the liquid precursor 5 raised to the second level H2, the lighting unit 19 is actuated such as to position the light beam 21 at selected regions over the substrate 9, in this embodiment by scanning the light beam 21, and thereby effects the deposition of material deposits over the substrate 9 in a second material layer L2 having a pattern in accordance with the required three-dimensional object 11.

This re-setting of the level of the liquid precursor 5 and the deposition of material layers is repeated until fabrication of the three-dimensional object 11 is complete.

FIG. 10 illustrates a fabrication apparatus in accordance with a fourth embodiment of the present invention.

The apparatus comprises a support unit 107 for supporting a substrate 109 on which a three-dimensional object 111 is to be fabricated.

In this embodiment the substrate 109 is formed of a ceramic material. In other embodiments the substrate 109 could be formed of metals, glasses or polymeric materials.

The support unit 107 comprises a movable platform 115 on which the substrate 109 is supported, and a platform positioner 117 which is operable to position the platform 115, and hence the supported substrate 9.

In this embodiment the platform positioner 117 comprises a table, as a three-axis positioner, which is positionable in X, Y and Z axes.

In an alternative embodiment the platform positioner 117 could comprise a six-axis positioner which provides for both rotation and translation of the substrate 109.

The apparatus further comprises a liquid precursor application unit 119 which is operable to apply one or more liquid precursors 121 to the upper surface of the substrate 109.

In this embodiment the one or more liquid precursors 121 comprise solutions, in one embodiment sol or colloidal solutions. The one or more liquid precursors 121 can be based on one or more of metal salts, including metal nitrates and metal sulphates, metal hydroxides, metal halides, metal hydrides, metal acetates, metalorganics, organometallics and alkoxides, where formulated with any of water and organic or inorganic solvents.

In one embodiment the one or more liquid precursors 121 can include a photosensitizer which promotes the transfer of the photon energy to the chemical precursor.

In this embodiment the liquid precursor application unit 119 comprises a tank unit 123 which separately contains one or more liquid precursors 121, and a delivery nozzle 125 which is operable to deliver a volume of the one or more liquid precursors 121 from the tank unit 123 to the upper surface of the substrate 109.

The apparatus further comprises a film setting unit 127 which is operable to act on a liquid precursor 121 as applied to the upper surface of the substrate 109 such as to provide a film of the liquid precursor 121 of a predetermined depth over the upper surface of the substrate 109.

In this embodiment the film setting unit 127 comprises a wiper 129 which is movable at a predetermined height over the upper surface of the substrate 109 such as to provide a film of the liquid precursor 121 of a predetermined depth over the upper surface of the substrate 109, and a drive 131 which is operable to drive the wiper 129 over the upper surface of the substrate 109.

The apparatus further comprises a lighting unit 133 for providing a light beam 135 to irradiate an upper surface of the substrate 109.

The lighting unit 133 comprises a light source 137 which generates the light beam 135 and a light beam positioner 139 which operates on the light source 137 such as position the light beam 135 selectively to irradiate regions over the substrate 109, in this embodiment by scanning the light beam 135 over the substrate 109.

In this embodiment the light source 137 comprises a light-emitting element 141, and optical elements 143 which are configurable by the light beam positioner 139 to provide for the selective positioning of the light beam 135.

In an alternative embodiment the light beam positioner 139 could be configured to move the entire light source 137.

In this embodiment the light-emitting element 141 comprises a laser, such as a CO₂ laser, a Nd-YAG laser and an excimer laser, which provides a focussed light beam. In one embodiment the laser could be a pulsed laser. In another embodiment the laser could be a continuous laser.

The light beam 135 has an intensity which is such as induce one or both of the photothermal and/or photolytic reaction of the liquid precursor 121 at a surface on the substrate 109, which causes one or both of the dissociation and chemical reaction of the liquid precursor 121 at the surface of the substrate 109, and results in the deposition of a solid deposit. By selectively irradiating regions over the substrate 109, a three-dimensional object 111 can be fabricated in a layer-by-layer fashion, as will be described in more detail hereinbelow.

The apparatus further comprises a control unit 145 for controlling the support unit 107, the liquid precursor application unit 119, the film setting unit 127 and the lighting unit 133 in the fabrication of a three-dimensional object 111. In this embodiment the control unit 145 is a computer-controlled unit.

Operation of the apparatus will now be described hereinbelow with particular reference to FIGS. 11 to 16 of the accompanying drawings.

A substrate 109, on which a three-dimensional object 111 is to be fabricated, is first located on the platform 115 of the support unit 107, and positioned both in the X, Y plane and at a first height Z1 in the Z axis.

As illustrated in FIG. 11, the delivery nozzle 125 of the liquid precursor application unit 119 is actuated to deliver a volume of a liquid precursor 121 from the tank unit 123 of the liquid precursor application unit 119 onto the upper surface of the substrate 109.

As illustrated in FIG. 12, the drive 131 of the film setting unit 127 is then actuated such as to drive the wiper 129 of the film setting unit 127 over the upper surface of the substrate 109 and provide a film of the liquid precursor 121 of a predetermined depth D over the upper surface of the substrate 109.

As illustrated in FIG. 13, the lighting unit 133 is then actuated such as to position the light beam 135 at selected regions over the substrate 109, in this embodiment by scanning the light beam 135, and thereby effects the deposition of material deposits over the substrate 109 in a first material layer L1 having a pattern in accordance with the required three-dimensional object 111.

Following fabrication of the first material layer L1, as illustrated in FIG. 14, the substrate 109 is re-positioned at a second, lower height Z2.

With the substrate 109 positioned at the second height Z2, again as illustrated in FIG. 14, the delivery nozzle 125 of the liquid precursor application unit 119 is actuated to deliver a volume of a liquid precursor 121 from the tank unit 123 of the liquid precursor application unit 119 onto the upper surface of the substrate 109 as defined by the upper surface of the first material layer L1.

As illustrated in FIG. 15, the drive 131 of the film setting unit 127 is then actuated such as to drive the wiper 129 of the film setting unit 127 over the upper surface of the substrate 109 as defined by the upper surface of the first material layer L1 and provide a film of the liquid precursor 121 of a predetermined depth D over the upper surface of the substrate 109.

As illustrated in FIG. 16, the lighting unit 133 is then actuated such as to position the light beam 135 at selected regions over the substrate 109, in this embodiment by scanning the light beam 135, and thereby effects the deposition of material deposits over the substrate 109 in a second material layer L2 having a pattern in accordance with the required three-dimensional object 111.

This re-positioning of the height of the substrate 109, the application of films of the liquid precursor 121 and the deposition of material layers is repeated until fabrication of the three-dimensional object 111 is complete.

The apparatus provides for the in situ fabrication of objects 111 of metals, including metal alloys, ceramics, cermet materials and organic-inorganic hybrid materials.

The apparatus also provides for the fabrication of composite materials, such as metal, ceramic and polymer matrix materials.

In one embodiment, where the liquid precursor 121 is a clear solution, both the matrix material and the re-inforcement material can be formed in situ directly from the liquid precursor 121.

In another embodiment the liquid precursor 121 can comprise a solution containing a suspended re-inforcement material, such as particles and fibres, with the matrix material being formed from the solution.

In a further embodiment a reinforcement material, such as particles and fibres, can be introduced into the liquid precursor 121 during conversion thereof into the matrix material.

In a yet further embodiment the re-inforcement can be provided by a skeletal pre-form which is penetrated by the liquid precursor 121. In one embodiment, in the fabrication of a three-dimensional object 111, a plurality of pre-forms can be successively stacked on one the other. In one embodiment the skeletal pre-form can be formed of a heat-conductive material such as to provide for transmission of the heat developed by the light beam 135 of the lighting unit 133.

The objects 111 can be formed as solid, dense parts or solid, porous parts, or comprise both solid and dense regions.

In one embodiment the liquid precursor 121 can be maintained at a predetermined temperature, whether heated or cooled relative to ambient, such as to provide for controlled material deposition, typically by regulating the temperature of the liquid precursor 121 or the platform 115 of the support unit 107 on which the substrate 109 is supported.

In another embodiment a temperature gradient can be maintained in the liquid precursor 121, decreasing in a direction from the surface of the substrate 109, such as to promote controlled dissociation and/or chemical reaction at the surface of the substrate 109.

In one embodiment the liquid precursor 121 can be heated to such a temperature that conversion of the liquid precursor 121 can be effected by a light beam 135 of relatively low energy.

In one embodiment the apparatus can be utilized in an open atmosphere.

In another embodiment the apparatus can be provided in a closed environment.

In one embodiment a gaseous reactant can be utilized in conjunction with the liquid precursor 121.

In one embodiment a gaseous reactant can be introduced into the liquid precursor 121, where either dissolved in or bubbled through the liquid precursor 121.

In another embodiment, where the apparatus is provided in a closed environment, the gaseous reactant can be introduced into the closed atmosphere.

In a further embodiment a vapor reactant can be utilized in conjunction with the liquid precursor 121.

In one embodiment, where the apparatus is provided in a closed environment, the vapor reactant can be introduced into the closed atmosphere.

In this embodiment the apparatus is utilized at atmospheric pressure.

In other embodiments the apparatus could be utilized at below or above atmospheric pressure.

In one embodiment liquid precursors 121 of different composition can be applied in the deposition of each of the material layers, thus allowing for the fabrication of multi-layer objects 111, including brayer objects 111. Also, the application of liquid precursors 121 of different composition in the deposition of each of the material layers allows for the fabrication of compositionally and functionally graded structures.

FIG. 17 illustrates a fabrication apparatus in accordance with a fifth embodiment of the present invention.

The apparatus comprises a reservoir 203 for containing a liquid precursor 205.

In this embodiment the liquid precursor 205 comprises a solution, in one embodiment a sol or colloidal solution. The liquid precursor 205 can be based on one or more of metal salts, including metal nitrates and metal sulphates, metal hydroxides, metal halides, metal hydrides, metal acetates, metalorganics, organometallics and alkoxides, where formulated with any of water and organic or inorganic solvents.

In one embodiment the liquid precursor 205 can include a photosensitizer which promotes the transfer of the photon energy to the chemical precursor.

The apparatus further comprises a lighting unit 219 for providing a light beam 221 to irradiate the liquid precursor 205 contained in the reservoir 203.

The lighting unit 219 comprises a light source 223 which generates the light beam 221 and a light beam positioner 225 which operates on the light source 23 such as to move the light beam 221 through the liquid precursor 205, in this embodiment by scanning the light beam 221 through the liquid precursor 205.

In this embodiment the light source 223 comprises a light-emitting element 227, and optical elements 229 which are configurable by the light beam positioner 225 to provide for the movement of the light beam 221.

In an alternative embodiment the light beam positioner 225 could be configured to move the entire light source 223.

In this embodiment the light-emitting element 227 comprises a laser, such as a CO₂ laser, a Nd-YAG laser and an excimer laser, which provides a focussed light beam. In one embodiment the laser could be a pulsed laser. In another embodiment the laser could be a continuous laser.

The light beam 221 has an intensity which is such as induce one or both of the photothermal and/or photolytic reaction of the liquid precursor 205, which causes one or both of the dissociation and chemical reaction of the liquid precursor 205, and results in the fabrication of a powder. By controlling the composition of the liquid precursor 205, and the intensity and rate of movement of the light beam 221, the size of the fabricated powder can be controlled precisely, allowing for the fabrication of ultrafine, in particular nanosized, powders.

The apparatus further comprises a control unit 231 for controlling the lighting unit 219 in the fabrication of a powder. In this embodiment the control unit 231 is a computer-controlled unit.

In operation, the lighting unit 219 is actuated such as to move the light beam 221 through the liquid precursor 205 at a predetermined rate, and thereby effect the fabrication of a powder.

The apparatus provides for the in situ fabrication of powders of metals, including metal alloys, ceramics, cermet materials and organic-inorganic hybrid materials.

The powder can be formed as a solid, dense powder or a solid, porous powder.

In one embodiment the liquid precursor 205 can be maintained at a predetermined temperature, whether heated or cooled relative to ambient, such as to provide for controlled powder formation, typically by regulating the temperature of the liquid precursor 205.

In one embodiment the liquid precursor 205 can be heated to such a temperature that conversion of the liquid precursor 205 can be effected by a light beam 221 of relatively low energy.

In one embodiment the apparatus can be utilized in an open atmosphere.

In another embodiment the apparatus can be provided in a closed environment.

In one embodiment a gaseous reactant can be utilized in conjunction with the liquid precursor 205.

In one embodiment a gaseous reactant can be introduced into the liquid precursor 205, where either dissolved in or bubbled through the liquid precursor 205.

In this embodiment the apparatus is utilized at atmospheric pressure.

In other embodiments the apparatus could be utilized at below or above atmospheric pressure.

Finally, it will be understood that the present invention has been described in its preferred embodiments and can be modified in many different ways without departing from the scope of the invention as defined by the appended claims.

In one modification of the above-described embodiments, the light source 23, 137, 223 could be configured to provide a wide beam as opposed to a focussed beam, as typically generated by a laser. In such an embodiment, the light source 23, 137, 223 could comprise a lamp, such as an infra-red lamp, an ultraviolet lamp, an arc lamp or an RF lamp.

In another modification of the above-described first to fourth embodiments, the light source 23, 137 could be configured to project a light beam 21, 135 as an image in accordance with a required pattern onto the substrate 9, 109. Such an embodiment avoids the need selectively to position a focussed light beam 21, 135 on a surface of the substrate 9, 109.

In a further modification of the above-described first to fourth embodiments, instead of the lighting unit 19, 133 being moved in relation to the substrate 9, 109, the substrate 9, 109 could be moved in relation to the lighting unit 19, 133 by the operation of the support unit 7, 107, or the lighting unit 19, 133 and the substrate 9, 109 could both be moved relative to one another by operation of the support unit 7, 107 and the light beam positioner 25, 139.

In a yet further modification of the above-described first to fourth embodiments, the fabrication apparatuses can be utilized to fabricate three-dimensional coatings on objects, and also two-dimensional films, in particular patterned films, by operation of the apparatus to deposit a single material layer.

Also, in addition to the described deposition from the liquid precursor 5, 121, 205, the apparatus of the described embodiments can be modified to provide for electroless or electro-assisted deposition from the liquid precursor 5, 121, 205.

1. A fabrication method, comprising the steps of: providing a liquid precursor over a surface of the substrate; and irradiating at least a region of the surface of the substrate with a light beam such as to fabricate a structure thereon from the liquid precursor.

2. The method of claim 1, wherein the structure comprises one of a metal, ceramic, cermet material or an organic-inorganic hybrid material.

3. The method of claim 1, wherein the structure comprises a three-dimensional object or a three-dimensional coating on an object.

4. The method of claim 1, wherein the structure comprises a film, preferably a patterned film.

5. The method of claim 1, wherein the liquid precursor comprises a solution.

6. The method of claim 5, wherein the solution comprises a colloidal solution.

7. The method of claim 1, wherein the light beam comprises a focussed beam which is selectively positioned over at least a region of the surface of the substrate.

8. The method of claim 7, wherein the light beam is moved in relation to the substrate.

9. The method of claim 7, wherein the substrate is moved in relation to the light beam.

10. The method of claim 7, wherein the light beam and the substrate are both moved relative to one another.

11. The method of claim 7, wherein the focussed beam is scanned over at least a region of the surface of the substrate.

12. The method of claim 1, wherein the light beam comprises a wide beam which irradiates at least a region of the surface of the substrate.

13. The method of claim 12, wherein the light beam defines a predeterminable pattern which irradiates a region of the surface of the substrate.

14. The method of claim 1, wherein the structure is fabricated in situ as a solid structure.

15. The method of claim 14, wherein the structure comprises a solid, dense structure.

16. The method of claim 14, wherein the structure comprises a solid, porous structure.

17. The method of claim 14, wherein the structure comprises at least one solid, dense region and at least one solid, porous region.

18-26. (canceled)

27. A fabrication method, comprising the steps of: providing a reservoir of a liquid precursor; and irradiating the liquid precursor with a light beam such as to fabricate a powder from the liquid precursor.

28-32. (canceled)

33. A fabrication apparatus, comprising: a support unit for supporting a substrate; a liquid precursor provision unit for providing a liquid precursor over a surface of the substrate; and a lighting unit for irradiating at least a region over the surface of the substrate with a light beam to fabricate a structure thereon from the liquid precursor.

34-40. (canceled)

41. A fabrication apparatus, comprising: a reservoir for containing a liquid precursor; and a lighting unit for irradiating liquid precursor in the reservoir to fabricate a powder from the liquid precursor.

42. (canceled)
